(19) United States
(12) Patent Application Publication
(10) Pub. No.: US 2009/0080768 A1
(43) Pub. Date: Mar. 26, 2009

(54) RECOGNITION METHOD FOR IMAGES BY PROBING ALIMENTARY CANALS

(75) Inventors: SHAOU-GANG MIAOU, TAOYUAN COUNTY (TW); JENN-LUNG SU, TAOYUAN COUNTY (TW); RUNG-SHENG LIAO, TAOYUAN COUNTY (TW); FENG-LING CHANG, CHANGHUA COUNTY (TW); HSU-YAO TSAI, TAIPEI CITY (TW); TAH-YEONG LIN, LONG-TAN (TW); HAN-CHIANG HUANG, TAOYUAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHUNG SHAN INSTITUTE OF SCIENCE AND TECHNOLOGY, ARMAMENTS BUREAU, M.N.D., TAOYUAN COUNTY (TW)

(21) Appl. No.: 11/858,433

(22) Filed: Sep. 20, 2007

(51) Int. Cl. G06K 9/62

(52) U.S. Cl. 382/156

(57) ABSTRACT

The present invention relates to a recognition method for images by probing alimentary canals. First, series first image data is received. Then, according to a plurality of judgments, judge if the first image data exceeds a threshold value. If so, the image data is stored and second image data is inputted for recognition. Thereby, by the plurality of judgments with partially identical characteristics, multiple diseases can be recognized at a time, and repeated operation can be eliminated and the processing time be reduced. In addition, by integrating different recognition methods, the amount of system operation can be reduced, and the operation speed can be thereby improved.

### FIELD OF THE INVENTION

The present invention relates generally to a recognition method, and particularly to a recognition method for images by probing alimentary canals.

### BACKGROUND OF THE INVENTION

Starting from as early as 1795, many medical staffs performed examinations on alimentary canals. Traditional examination apparatuses are relatively rough and inconvenient in usage, and thereby they can only be applied for examining front end or backend of the alimentary canals. In order to improve convenience of examinations, the concept and invention of endoscopes are proposed. In the early stage, endoscopes suffer from light source and operational problems, thus the visibility thereof is not ideal. After optical-fiber image transmission becomes mature day-by-day, flexible endoscopes are brought into existence, improving the insufficient curvature of rigid endoscopes in the early stage.

Although endoscopes can improves the drawbacks of destructive examinations in operations of the internal medicine and the surgery, current examinations still need to enter from the mouth, pass through the throat, stomach, duodenum, and reach at most one meter past the pylorus of a human body. Alternatively, the endoscope can enter from the anus, pass through the rectum, the colon, and reach the end of the small intestines. Nevertheless, these two methods cannot probe the main part of the small intestines, which has around six meters. With the progress of technologies, a capsule-type endoscope is developed.

A capsule-type endoscope is a quite delicate electronic instrument with a volume size similar to the size of a cod-liver oil pill. It includes a lens, a wireless transmitter, an image sensor, an antenna, and a delicate battery. In terms of performance, the minimum object focus point of the capsule-type endoscope is less than 0.1 millimeter and the shooting rate is two color pictures per second. The wireless transmitter transmits the image signals outside the human body by means of the specially designed antenna, and the signals are received by a receiving device outside the human body.

Because the shooting rate of the capsule-type endoscope is two color pictures per second, and the retention time in the human body is around six to eight hours, there will be in total more than fifty thousand pictures taken. If each of the pictures has to be judged by a physician, time will be wasted very seriously. Thereby, several recognition systems are developed for performing preliminary recognition for various diseases. However, when performing disease recognition, recognition can be done disease-by-disease only, increasing computation amount of the systems as well as wasting processing time.

Consequently, a novel recognition method for images by probing alimentary canals according to the present invention is provided for improving the time-consuming drawback in the traditional image recognition method as well for recognizing various diseases. Hence, the problems described above can be solved.

### SUMMARY

An objective of the present invention is to provide a recognition method for images by probing alimentary canals, which can analyze simultaneously a plurality of diseases, eliminating repeated operations, and reducing processing time.

Another objective of the present invention is to provide a recognition method for images by probing alimentary canals, which integrates different recognition methods for reducing system operations and thus increasing the operation speed.

The recognition method for images by probing alimentary canals according to the present invention first receives first image data of series data. Then, judge if the image data exceeds a threshold value according to a plurality of judgment methods. If so, the first image data is stored and second image data is inputted. Thereby, various diseases can be recognized.

In addition, the recognition method for images by probing alimentary canals according to the present invention can probe chyme block, bowel bleeding, and white spots in the alimentary canals. First, judge if the first image data exceeds a first threshold value. If so, the first image data is stored, and second image data is inputted for recognition. Otherwise, judge if the first image data exceeds a second threshold value. If so, the first image data is stored, and the second image data is inputted for recognition. Otherwise, binarize the first image data and compile statistics on the numbers of light and dark points in the first image data. Judge if the numbers of light and dark points exceeds a third threshold value. If so, the second image data is inputted for re-recognition. Afterwards, different color-space values of the first image data are combined to produce a grey-scale co-occurrence matrix. In addition, according to the grey-scale co-occurrence matrix, an input value is inputted to a neural network for producing an output value. When the output value exceeds a fourth threshold value, the first image data is stored, and the second image data is inputted for recognition.

### BRIEF DESCRIPTION OF THE DRAWINGS

FIG. 1 shows a flowchart according to a preferred embodiment of the present invention;

FIG. 2A shows a color space diagram of the first image data judged normal;

FIG. 2B shows a color space diagram of the first image data judged abnormal; and

FIG. 3 shows the experimental data according to a preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

The recognition method for images by probing alimentary canals according to the present invention can perform preliminary recognition of two and more diseases at the same time. Then, the medical staffs can perform final judgment. Thereby, detecting one signal disease a time by a system can be prevented, and hence the processing time and the operation amount of the system can be reduced. As a result, the operation speed is improved.

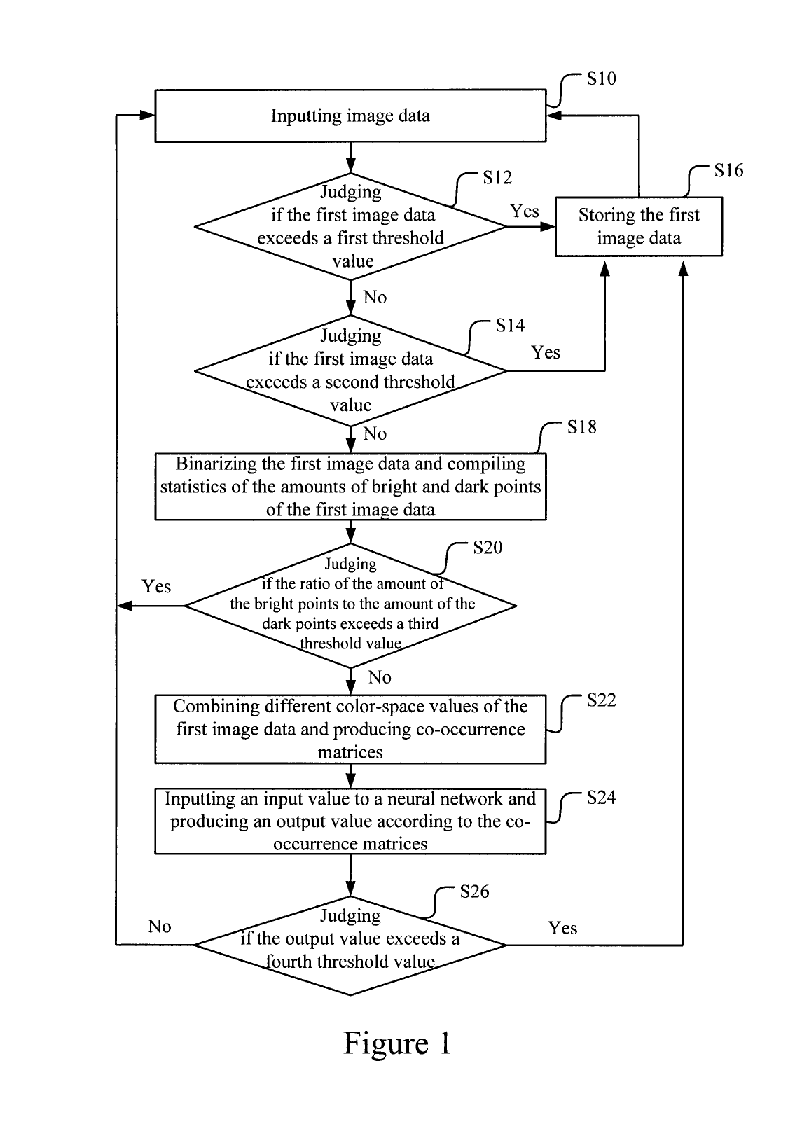

FIG. 1 shows a flowchart according to a preferred embodiment of the present invention. As shown in the figure, first, the step S10 is executed for inputting series image data, which receives first image data and converts the first image data to the hue, saturation, and intensity (HSI) color space. That is, to receive the first image data, which is a series image data, and to convert the first image data to the HSI color space from the red, green, and blue (RGB) color space. Thereby, according to the present preferred embodiment, a HS circle (hue-saturation circle) is formed by collecting the pixels with identical hue and saturation. The relation between hue and saturation can be expressed in the HS-circle format, which is a circular color plate arranged counterclockwise according to the angle of the hue values (0 to 360 degrees) with saturation being the radius (0% at the center and 100% at the periphery). In addition, image data usually includes main information, which is desired, and background information. Before performing recognition using multiple algorithms, it is necessary to separate main information from background information. This is because if the whole image data is recognized directly, the result is subject to interference of the background information. Hence, the grey-scale binarization is applied with the accompanying filtering processes, and thus region of interest (ROI) is selected.

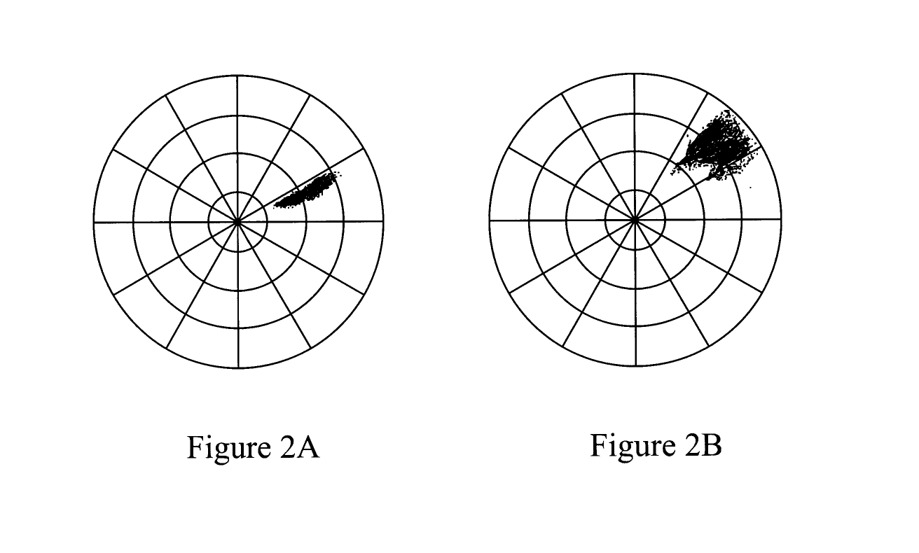

Next, the step S12 is executed for judging if the first image data exceeds a first threshold value. In the case of judging intestinal chyme block, the yellowish green color appears. In addition, the area of the nidus is large with apparent color images. Thereby, the computer can easily judge intestinal obstruction according to the HSI color representation of the nidus. FIGS. 2A and 2B show color representation diagrams of normal and abnormal conditions. FIG. 2A shows a HS color representation diagram of normal intestines. The hue and saturation of the image data will fall between 15 to 30 degrees and 10% to 75%, respectively. FIG. 2B shows a HS color space diagram of abnormal intestines. The hue and saturation of the image data will fall between 40 to 60 degrees and 40% to 100%, respectively. When the first image data is inputted, the pixel values of the first image data will be gathered for statistics. When the proportion of the pixels of the first image data with abnormal HS color values exceeds a first threshold value, the first image data is judged abnormal. When this occurs, the recognition system will store the first image data (as in the step S16) for the medical staffs for further diagnosis. Besides, the second image data, which is the next image data, is inputted.

When the first image data is not judged abnormal, next recognition method is performed. The step S14 is executed for judging if the first image exceeds a second threshold value. If so, the first image data is stored. According to the present preferred embodiment, the fuzzy c-means (FCM) clustering algorithm is applied for identifying if the first image data is red or not. That is, to identify whether the alimentary canals have the color of bowel bleeding or the color of intestinal wall. Two center points are used to identify to which group the first image data belongs. That is to say, the center of bowel bleeding group and the center of bowel non-bleeding group are used as the lustering c centers for classification. When a pixel of the first image data is closer to a center point of said two groups, the pixel is judged to belong to that very group (bowel bleeding or bowel non-bleeding group) having the center point. If the majority of the first image data belongs to the bowel bleeding group, that is, the proportion of the pixels of the first image data in the bowel bleeding group is greater than the second threshold value, the first image data is judged abnormal. The recognition system will store the first image data (as shown in the step S14) for the medical staffs for further diagnosis. The (R, G, B) coordinate of the center point of the bowel bleeding group is (108.12, 41.993, 17.215), while that of the center point of the bowel non-bleeding group is (203.46, 117.92, 94.397). In the great amount of series images of the capsule-type endoscope, taking the RGB-range of a single image having red-abnormality for example, it is not possible to approximate all possible RGB distribution of abnormal parts. Thereby, the abnormal image files are trained one-by-one and sequentially by using the FCM algorithm. The range of the initial clustering center is set by empirical values. After training with multiple images of bowel bleeding, the final clustering center is found. With this process, the most proper characteristic values can be approximated gradually. The FCM algorithm described above is only a method according to a preferred embodiment of the present invention, and is not used to confine the methods of the present invention.

After the primary and secondary judgments, large-area abnormal images are ruled out. Thereby, smaller-area recognition for abnormal images will be performed subsequently. In the previous recognition methods, yellow-tone and green-tone abnormal phenomena are filtered, and the remaining images are mainly belonging to white. If intestinal white spots are to be recognized directly, it is easy to make wrong recognition. Hence, preliminary recognition is needed. The difference between the present recognition method and the previous one is that in the present recognition, the main task is to pick out the normal images. The step S18 is executed for binarizing the first image data and compiling statistics of the amounts of bright and dark points of the first image data. Binarizing the first image data means dividing the pixels of the first image data into bright and dark points, which have pixel values 255 and 0, respectively. Then, the step S20 is executed for judging if the amounts of the bright and the dark points exceed a third threshold value. If the proportion of the bright point exceeds the third threshold value, the second image is inputted for recognition. In this step, it is necessary to first convert the first image data from the RGB color space to the HSI color representation, to binarize the hue-color component (H component) according to a threshold value of 20, and to count the numbers of the bright points (255) and of the dark points (0). When the amounts of the bright and the dark points exceed the third threshold value, the next image data is inputted for recognizing the second image data. In such a circumstance, the first image data is judged normal.

In addition, after the first two recognition methods, it is supposed that except for normal images, no large-area uniform color case will occur. Thereby, the simple judgment method based on H-component is applied. In addition to normal image with normal luminance, it is desired that uniform images with dark tone can be picked out as well. However, the previous recognition methods are aimed for selecting abnormal images, and leaving normal images to the next recognition method for identification with more precision. In the third recognition method, if the first image data is again judged normal, there will no further identification. Thereby, in order to avoid leaving out abnormal images, the most loose threshold value of the third recognition method is given. That is, only normal images with real uniformity will be picked without further recognition. Images with a slight possibility of being abnormal will need to pass the fourth recognition method. After the fourth recognition, images judged abnormal will be stored and displayed for physicians' inspection.

Next, the fourth recognition method is performed, which aims on the abnormal phenomenon of white spots. Such kind of abnormal phenomenon has irregular shapes, and the spots are not necessarily connected. Besides, the area of abnormal region is smaller than that of the primary and secondary recognitions. Thereby, a more complicated recognition method will be adopted. Here, the back-propagation neural network (BPNN) will be used.

First, convert the first image data into AC1C2-color space, and execute the step S22 for combining different color-space values of the first image data and producing corresponding co-occurrence matrices. For each of the nine-dimensional color-space values used in the recognition methods described above, which color space includes the nine color coordinates of RGB, HSI, and AC1C2, one or more associated co-occurrence matrices are formed. Given a co-occurrence matrix, the four statistical values can be given by the following equations:

$$Contrast = {\sum }_{i} {\sum }_{j} {\vert i - j \vert}^{2} {p}_{ϕ , d} ( i , j )$$

$$Energy = {\sum }_{i} {\sum }_{j} {p}_{ϕ , d}^{2} ( i , j )$$

$$Entropy = {\sum }_{i} {\sum }_{j} {p}_{ϕ , d} ( i , j ) {log}_{2} {p}_{ϕ , d} ( i , j )$$

$$Uniformity = {\sum }_{i} {\sum }_{j} \frac{{p}_{ϕ , d} ( i , j )}{1 + \vert i - j \vert}$$

where p_{φ,d} is the grey-scale co-occurrence matrix, φ and d are the orientation relationship and the distance between co-occurring pixels, respectively. According to the present preferred embodiment, 0°- and 90°-orientations are adopted, and the distance is one pixel (which means adjacent pixels) for the co-occurrence matrix. Thus there will be in total of 2×9=18 co-occurrence matrices, and since four statistical values are generated from the co-occurrence matrix, the input vector dimension of the BPNN is 18×4=72.

First, the first image data is cut into 256 sub-images with 16×16 pixels each. By considering effective information, the sub-images on and outside the boundary of ROI are ignored, and only 152 sub-images are left. Then, for each of the sub-images, characteristics are extracted, and BPNN training and testing are performed thereon. Since the input vector has 72 parameters, the number of the BPNN input neural units is 72. The output only needs to judge abnormal or normal, thereby the number of the output neural units is one. The number of neural units in the hidden layer is given by averaging the numbers of the input and output neural units and then rounding off, resulting in 37 neural units. Afterwards, by using BPNN to train and converge, the weight and threshold values can be given, and the testing part can be performed subsequently. While testing, take 152 sub-images for each image. For each of the sub-images, BPNN is performed once for judging abnormality. If the number of abnormal sub-pictures exceeds a pre-determined threshold value, the image is judged abnormal. Here, the empirical threshold value is used as the final threshold value. That is, the threshold value is a fourth threshold value.

Furthermore, because the capsule-type endoscopy is not popular presently, and the data is difficult to collect, the amount of images for BPNN training and testing is not sufficient for white spot abnormality. Accordingly, the present embodiment of sub-image approach is only a preferred embodiment, but not used to confine the recognition method and verification method.

Next, the step S24 is executed for inputting an input value to a neural network and producing an output value according to the co-occurrence matrix. When the output value exceeds the fourth threshold value (as shown in the step S26), the first image data is stored, and the second image data will be inputted for recognition. The input value is produced according to the co-occurrence matrix for inputting to the trained BPNN. Thus, the correct result will be outputted, and according to the BPNN, it is judged if white spots appear in the alimentary canals. When the output value is one, it means that white spots appear. On the contrary, when the output value is zero, it means that no white spot appears, and that the first image data is normal. When white spots are identified the recognition system will store the first image data (as shown in the step S16) for further diagnosis by the medical staffs, and the second image data, which is the next image data, will be inputted.

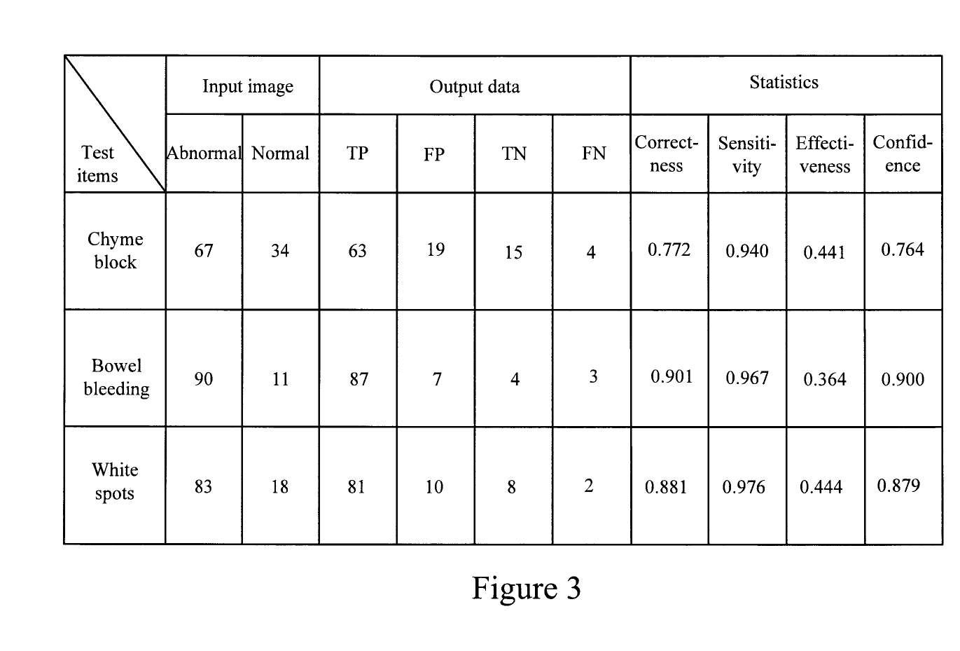

FIG. 3 shows the experimental data according to a preferred embodiment of the present invention. As shown in the figure, the correctness rate is greater than 77%. The TP represents the number of being symptomatic with a symptomatic judgment by the system; the TN represents the number of being not symptomatic with a non-symptomatic judgment by the system; the FP represents the number of being not symptomatic with a symptomatic judgment by the system; and the FN represents the number of being symptomatic with a non-symptomatic judgment by the system. The correctness rate refers to the correctness rate judged by the system; the sensitivity is the ratio of being symptomatic with a symptomatic judgment by the system; the effectiveness is the ratio of being not symptomatic with a non-symptomatic judgment by the system; and the confidence is the confidence appraisal on the diagnostic results of the system.

To sum up, the recognition method for images by probing alimentary canals first receives first image data. Then, according to a plurality of judgments, judge if the first image data exceeds a threshold value. If so, the image data is stored and second image data is inputted for recognition. Thereby, multiple diseases can be recognized at a time, and repeated operation can be eliminated and the processing time be reduced.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A recognition method for images by probing alimentary canals, comprising the steps of:
judging if the proportion of pixel values of first image data exceeds a first threshold value, then storing the first image data and inputting second image data for recognition;
judging if the proportion of pixel values of the first image data exceeds a second threshold value, then storing the first image data and inputting the second image data for recognition;
binarizing the first image data, compiling statistics of the amounts of bright and dark points of the first image data, and judging if the ratio of the amount of the bright points to the amount of the dark points exceeds a third threshold value, then inputting the second image data for recognition;
combining different color-space values of the first image data and producing co-occurrence matrices; and
inputting an input value to a neural network and producing an output value according to the co-occurrence matrix, and when the output value exceeds a fourth threshold value, storing the first image data and inputting the second image data for recognition.

2. The method of claim 1, wherein before the step of judging if the proportion of pixel values of first image data exceeds a first threshold value, then storing the first image data and inputting second image data for recognition, it further includes a step of converting the first image data into the hue, saturation, and intensity color space.

3. The method of claim 2, wherein the hue of the first threshold value is between 40 degrees and 60 degrees, and the saturation thereof is between 40% and 100%.

4. The method of claim 1, wherein the step of judging if the proportion of pixel values of the first image data exceeds a second threshold value, then storing the first image data and inputting the second image data for recognition adopts the fuzzy c-means (FCM) clustering algorithm.

5. The method of claim 1, wherein before the step of binarizing the first image data, compiling statistics of the amounts of bright and dark points of the first image data, and judging if the ratio of the amount of the bright points to the amount of the dark points exceeds a third threshold value, then inputting the second image data for recognition, it further includes a step of converting the first image data into the hue, saturation, and intensity color space.

6. The method of claim 5, wherein binarizing the first image data is binarizing the hue value of the first image data according to a threshold value.

7. The method of claim 6, wherein the threshold value is 20.

8. The method of claim 1, wherein before the step of combining different color-space values of the first image data and producing a grey-scale co-occurrence matrix, it further includes a step of converting the first image data into the AC1C2 color space.

9. The method of claim 1, wherein the neural network adopts the back-propagation neural network (BPNN).

10. A recognition method for images by probing alimentary canals, comprising the steps of:
receiving first image data; and
judging if the first image data exceeds a threshold value according to a plurality of judgment methods, then storing the first image data and inputting second image data.

11. The method of claim 10, wherein the step of judging if the first image data exceeds a threshold value according to a plurality of judgment methods, then storing the first image data and inputting second image data further includes judging if the proportion of pixel values of first image data exceeds a first threshold value, then storing the first image data and inputting second image data for recognition.

12. The method of claim 11, wherein before the step of judging if the first image data exceeds a threshold value according to a plurality of judgment methods, then storing the first image data and inputting second image data, it further includes a step of converting the first image data into the hue, saturation, and intensity color space.

13. The method of claim 12, wherein the hue of the first threshold value is between 40 degrees and 60 degrees, and the saturation thereof is between 40% and 100%.

14. The method of claim 10, wherein the step of judging if the first image data exceeds a threshold value according to a plurality of judgment methods, then storing the first image data and inputting second image data further includes judging if the proportion of pixel values of the first image data exceeds a second threshold value, then storing the first image data and inputting the second image data for recognition.

15. The method of claim 14, wherein the step of judging if the proportion of pixel values of the first image data exceeds a second threshold value, then storing the first image data and inputting the second image data for recognition adopts the fuzzy c-means (FCM) clustering algorithm.

16. The method of claim 10, wherein the step of judging if the first image data exceeds a threshold value according to a plurality of judgment methods, then storing the first image data and inputting second image data further includes binarizing the first image data, compiling statistics of the amounts of bright and dark points of the first image data, and judging if the ratio of the amount of the bright points to the amount of the dark points exceeds a third threshold value, then inputting the second image data for recognition.

17. The method of claim 16, wherein before the step of binarizing the first image data, compiling statistics of the amounts of bright and dark points of the first image data, and judging if the ratio of the amount of the bright points to the amount of the dark points exceeds a third threshold value, then inputting the second image data for recognition, it further includes a step of converting the first image data into the hue, saturation, and intensity color space.

18. The method of claim 17, wherein binarizing the first image data is binarizing the hue value of the first image data according to a threshold value.

19. The method of claim 18, wherein the threshold value is 20.

20. The method of claim 10, wherein the step of judging if the first image data exceeds a threshold value according to a plurality of judgment methods, then storing the first image data and inputting second image data further includes:
combining different color-space values of the first image data and producing a co-occurrence matrix; and
inputting an input value to a neural network and producing an output value according to the co-occurrence matrix, and when the output value exceeds a fourth threshold value, storing the first image data and inputting the second image data for recognition.

21. The method of claim 20, wherein before the step of combining different color-space values of the first image data and producing a co-occurrence matrix, it further includes a step of converting the first image data into the AC1C2 color space.

22. The method of claim 20, wherein the neural network adopts the back-propagation neural network (BPNN).
